(19) United States
(12) Patent Application Publication
(10) Pub. No.: US 2014/0089646 A1
(43) Pub. Date: Mar. 27, 2014

(54) PROCESSOR WITH INTERRUPTABLE INSTRUCTION EXECUTION

(71) Applicant: TEXAS INSTRUMENTS INCORPORATED, Dallas, TX (US)

(72) Inventors: Horst DIEWALD, Freising (DE); Johann ZIPPERER, Unterschleissheim (DE)

(73) Assignee: TEXAS INSTRUMENTS INCORPORATED, Dallas, TX (US)

(21) Appl. No.: 13/628,377

(22) Filed: Sep. 27, 2012

(51) Int. Cl. G06F 9/38

(52) U.S. Cl. 712/234; 712/E09.045

(57) ABSTRACT

A processor includes a plurality of execution units. Each of the execution units includes a status register configured to store a value indicative of state of the execution unit. At least one of the execution units is configured to execute a complex instruction that requires multiple instruction cycles to execute. The at least one of the execution units is also configured to interrupt execution of the complex instruction to execute a different instruction, and resume, based on the value stored in the status register, execution of the complex instruction at the point interrupted after execution of the different instruction.

### BACKGROUND

Microprocessors (processors) are instruction execution devices that are applied, in various forms, to provide control, communication, data processing capabilities, etc. to an incorporating system. Processors include execution units to provide data manipulation functionality. Exemplary execution units may provide arithmetic operations, logical operations, floating point operations etc. Processors invoke the functionality of the execution units in accordance with the requirements of the instructions executed by the processor.

### SUMMARY

A processor and execution unit for low-power consumption systems providing real-time interrupt response are disclosed herein. In one embodiment, a processor includes a plurality of execution units. Each of the execution units includes a status register configured to store a value indicative of state of the execution unit. At least one of the execution units is configured to execute a complex instruction that requires multiple instruction cycles to execute. The at least one of the execution units is also configured to suspend execution of the complex instruction to execute a different instruction, and resume, based on the value stored in the status register, execution of the complex instruction at the point interrupted after execution of the different instruction.

In some embodiments, an execution unit for executing instructions in a processor includes instruction execution logic. The instruction execution logic is configured to execute a multi-cycle instruction, and to suspend execution of the multi-cycle instruction prior to completion based on reception of a different instruction by the instruction execution logic. The instruction execution logic is further configured to execute the different instruction while execution of the multi-cycle instruction is suspended, and to resume execution of the multi-cycle instruction based on completion of execution of the different instruction.

In other embodiments, a method for executing instructions in an execution unit of a processor includes executing, by the execution unit, a complex instruction requiring a plurality of instruction cycles to execute. A different instruction for execution is received by the execution unit while executing the complex instruction. Execution of the complex instruction is suspended, by the execution unit, responsive to the receiving. The different instruction is executed by the execution unit while the complex instruction is interrupted. Execution of the complex instruction is resumed by the execution unit based on completion of execution of the different instruction

### BRIEF DESCRIPTION OF THE DRAWINGS

For a detailed description of exemplary embodiments of the invention, reference will now be made to the accompanying drawings in which:

FIG. 1 shows a block diagram of a processor in accordance with various embodiments;

FIG. 2 shows a block diagram for an execution unit in accordance with various embodiments;

FIGS. 3 and 4 show exemplary instruction flows incorporating interrupting of a complex instruction in accordance with various embodiments;

FIG. 5 shows a block diagram for a signal processing system including an execution unit in accordance with various embodiments; and

FIG. 6 shows a flow diagram for a method for executing a complex instruction by a processor in accordance with various embodiments.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct electrical connection. Thus, if a first device couples to a second device, that connection may be through a direct electrical connection, or through an indirect electrical connection via other devices and connections. Further, the term “software” includes any executable code capable of running on a processor, regardless of the media used to store the software. Thus, code stored in memory (e.g., non-volatile memory), and sometimes referred to as “embedded firmware,” is included within the definition of software. The recitation “based on” is intended to mean “based at least in part on.” Therefore, if X is based on Y, X may be based on Y and any number of other factors.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Execution units implemented in various processor architectures may require one or more instruction cycles to execute an instruction. For example, a reduced instruction set architecture may execute simple instructions in a single instruction cycle, while a complex instruction set architecture may execute complex instructions in a plurality of instruction cycles. Inclusion of execution units configured to execute complex instructions allows for efficient provision of complicated functionality. However, in applications requiring timely response to interrupts, such as real-time embedded applications, execution of complex instructions, which may require thousands of instruction cycles to execute, can substantially degrade real-time performance.

Embodiments of the processor disclosed herein include a plurality of execution units configured to execute different instructions in parallel. Embodiments of the execution units may execute complex instructions that require multiple (e.g., thousands) cycles to execute. To facilitate real-time processing, embodiments of the processor allow one execution unit to continue execution of a complex instruction while another execution unit executes the instructions of an interrupt service routine. Embodiments further facilitate real-time processing by allowing an execution unit to suspend execution of a complex instruction, execute a different instruction, and resume execution of the complex instruction after executing the different instruction. Execution of complex instructions in the disclosed execution units allows embodiments of the processor to provide complex functionality with reduced power consumption relative to single cycle instruction architectures.

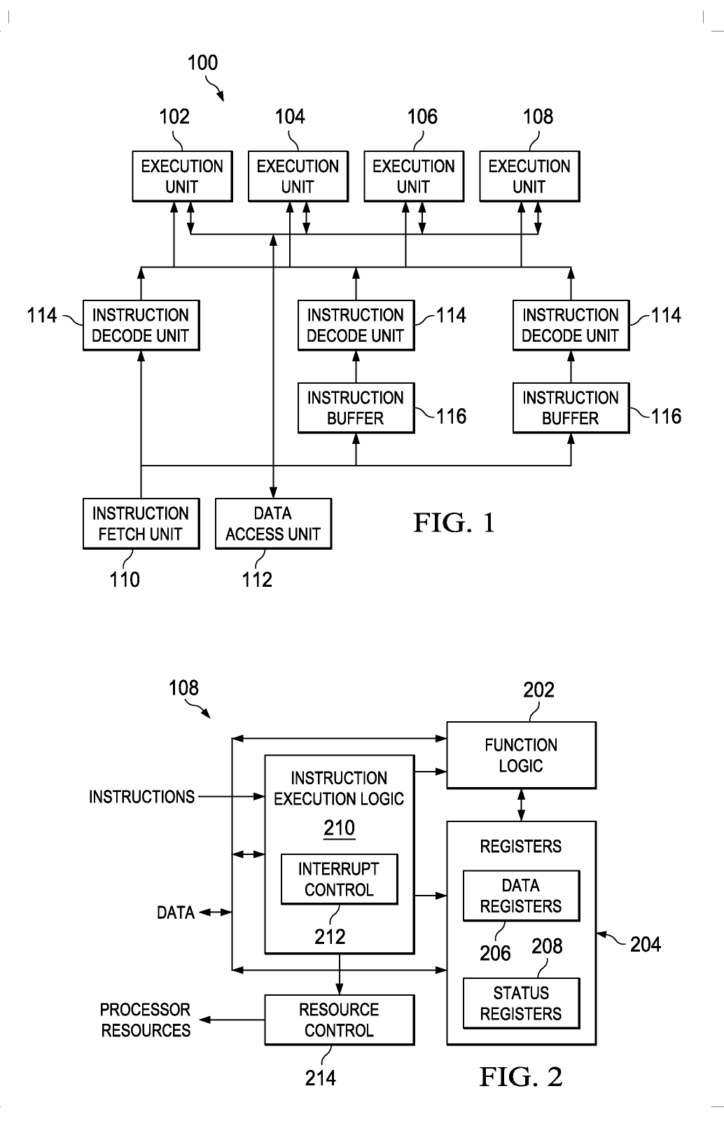

FIG. 1 shows a block diagram of a processor 100 in accordance with various embodiments. The processor 100 includes a plurality of execution units 102, 104, 106, 108. Other embodiments may include one or more execution units. The processor 100 also includes an instruction fetch unit 110, a data access unit 112, and one or more instruction decode units 114. Some embodiments further include one or more instruction buffers 116. The processor 100 may also include other components and sub-systems that are omitted from FIG. 1 in the interest of clarity. For example, the processor 100 may include data storage resources, such as random access memory, communication interfaces and peripherals, timers, analog-to-digital converters, clock generators, debug logic, etc.

One or more of the execution units 102-108 can execute a complex instruction. For example, an execution unit 102-108 may be configured to execute a fast Fourier transform (FFT), execute a finite impulse response (FIR) filter, solve a trigonometric function, solve a polynomial, etc. The execution units 102-108 allow complex instructions to be interrupted prior to completion of the instruction's execution. While an execution unit (e.g., EU 108) is servicing an interrupt, other execution units (EU 102-106) continue to execute instructions. The execution units 102-108 may synchronize operation based on a requirement for a result and/or status generated by a different execution unit. For example, an execution unit 102 that requires a result value from execution unit 104 may stall until the execution unit 104 has produced the required result. One execution unit, e.g., a primary execution unit, may provide instructions to, or otherwise control the instruction execution sequence of, other execution units. Embodiments of the execution units 102-108 may also group or concatenate successive instructions and execute the concatenated instructions as a single instruction. For example, embodiments of the execution units 102-108 may disable interrupting of concatenated instructions.

The instruction fetch unit 110 retrieves instructions from storage (not shown) for execution by the processor 100. The instruction fetch unit 110 may provide the retrieved instructions to a decode unit 114. The decode unit 114 examines instructions, locates the various control sub-fields of the instructions, and generates decoded instructions for execution by the execution units 102-108. As shown in FIG. 1, multiple execution units may receive decoded instructions from an instruction decoder 114. In some embodiments, an instruction decoder 114 may be dedicated one or more execution units. Thus, each execution unit 102-108 may receive decoded instructions from an instruction decoder 114 coupled to only that execution unit, and/or from an instruction decoder 114 coupled to a plurality of execution units 102-108. Some embodiments of the processor 100 may also include more than one fetch unit 110, where a fetch unit 110 may provide instructions to one or more instruction decoder 114.

Embodiments of the processor 100 may also include one or more instruction buffers 116. The instruction buffers 116 store instructions for execution by the execution units 102-108. An instruction buffer 116 may be coupled to one or more execution units 102-108. An execution unit may execute instructions stored in an instruction buffer 116, thereby allowing other portions of the processor 100, for example other instruction buffers 116, instruction fetch unit 110 and instruction storage (not shown), etc., to be maintained in a low-power or inoperative state (i.e., a non-operation mode). An execution unit may lock or freeze a portion of an instruction buffer 116, thereby preventing the instructions stored in the locked portion of the instruction buffer 116 from being overwritten. Execution of instructions stored in an instruction buffer 116 (e.g., a locked portion of an instruction buffer 116) may save power as no reloading of the instructions from external memory is necessary, and may speed up execution when the execution unit executing the instructions is exiting a low-power state. An execution unit may call instructions stored in a locked portion of an instruction buffer 116 and return to any available power mode and/or any state or instruction location. The execution units 102-108 may also bypass an instruction buffer 116 to execute instructions not stored in the instruction buffer 116. For example, the execution unit 104 may execute instructions provided from the instruction buffer 116, instructions provided by the instruction fetch unit 110 that bypass the instruction buffer 116, and/or instructions provided by an execution unit 102, 106-108.

The instruction buffers 116 may also store, in conjunction with an instruction, control or other data that facilitate instruction execution. For example, information specifying a source of an instruction execution trigger, trigger conditions and/or trigger wait conditions, instruction sequencing information, information specifying whether a different execution unit or other processor hardware is to assist in instruction execution, etc. may be stored in an instruction buffer 116 in conjunction with an instruction.

The data access unit 112 retrieves data values from storage (not shown) and provides the retrieved data values to the execution units 102-108. Similarly, the data access unit 112 stores data values generated by the execution units 102-108 in a storage device (e.g., random access memory external to the processor 100). Some embodiments of the processor 100 may include more than one data access unit 112, where each data access unit 112 may be coupled to one or more of the execution units 102-108.

The execution units 102-108 may be configured to execute the same instructions, or different instructions. For example, given an instruction set that includes all of the instructions executable by the execution units 102-108, in some embodiments of the processor 100, all of the execution units 102-108 may be configured to execute all of the instructions of the instruction set. Alternatively, some execution units 102-108 may execute only a sub-set of the instructions of the instruction set. At least one of the execution units 102-108 is configured to execute a complex instruction that requires a plurality of instruction cycles to execute.

Each execution unit 102-108 is configured to control access to the resources of the processor 100 needed by the execution unit to execute an instruction. For example, each execution unit 102-108 can enable power to an instruction buffer 116 if the execution unit is to execute an instruction stored in the instruction buffer 116 while other instruction buffers, and other portions of the processor 100, remain in a low power state. Thus, each execution unit 102-108 is able to independently control access to resources of the processor 100 external to the execution unit needed to execute instructions, and to operate independently from other components of the processor 100.

FIG. 2 shows a block diagram for an execution unit 108 in accordance with various embodiments. The block diagram and explanation thereof may also be applicable to embodiments of the execution units 102-106. The execution unit 108 includes function logic 202, registers 204, and instruction execution logic 210. The function logic 202 includes the arithmetic, logical, and other data manipulation resources for executing the instructions relevant to the execution unit 108. For example, the function logic may include adders, multipliers, comparators, etc. for integer, fixed point, and/or floating point operations in accordance with the instructions to be executed by the execution unit 108.

The registers 204 include data registers 206 and status registers 208. The data registers 206 store operands to be processed by, and results produced by, the function logic 202. The number and/or size of registers included in the data registers 206 may vary across embodiments. For example, one embodiment may include 16 16-bit data registers, and another embodiment may include a different number and/or width of registers. The status registers 208 include one or more registers that store state information produced by operations performed by the function logic 202 and/or store instruction execution and/or execution unit state information. State information stored in a status register 208 may include a zero result indicator, a carry indicator, result sign indicator, overflow indicator, interrupt enable indicator, instruction execution state, etc. The registers 204 may also include registers that store addresses, configuration information, calibration information, etc.

The instruction execution logic 210 controls the sequencing of instruction execution in the execution unit 108. The instruction execution logic 210 may include one or more state machines that control the operations performed by the function logic 202 and transfer of data between the registers 204, the function logic 202, other execution units 102-106, the data access unit 112, and/or other components of the processor 100 in accordance with an instruction being executed. For example, the instruction execution logic 210 may include a state machine or other control device that sequences the multiple successive operations of a complex instruction being executed by the execution unit 108.

The instruction execution logic 210 includes interrupt control logic 212 that allows complex instructions executing in the execution unit 108 to be interrupted. The interrupt control logic 212 detects conditions, such as an interrupt event or reception of an instruction to be executed, that dictate interruption of a currently executing complex instruction. Responsive to detection of such a condition, the interrupt control logic 212 may cause the instruction execution logic 210 to suspend execution of the complex instruction and store in the registers 204, or other storage resource (e.g., a memory), information indicative of the state of the execution unit 108 at the point of suspension (e.g., status register values, relevant data values, instruction execution sequence information, etc.). When the complex instruction execution state information has been saved, the instruction execution logic 210 sequences the execution unit 108 through the operations of a first interrupt service instruction, and any subsequent interrupt service instructions. On completion of the interrupt service, the instruction execution logic 210 restores the saved complex instruction execution state information to the registers 204 and the instruction execution logic 210 and resumes execution of the interrupted complex instruction.

The execution unit 108 also includes resource control logic 214. The resource control logic 214 requests access to the various resources (e.g., storage, power, clock frequency, etc.) of the processor 100 that the execution unit 108 uses to execute an instruction. By requesting processor resources independently for each execution unit 102-108, the power consumed by the processor 100 may be reduced by placing only components of the processor 100 required for instruction execution by an active execution unit 102-108 in an active power state. Furthermore, execution units 102-108 not executing instructions may be placed in a low-power state to reduce the power consumption of the processor 100.

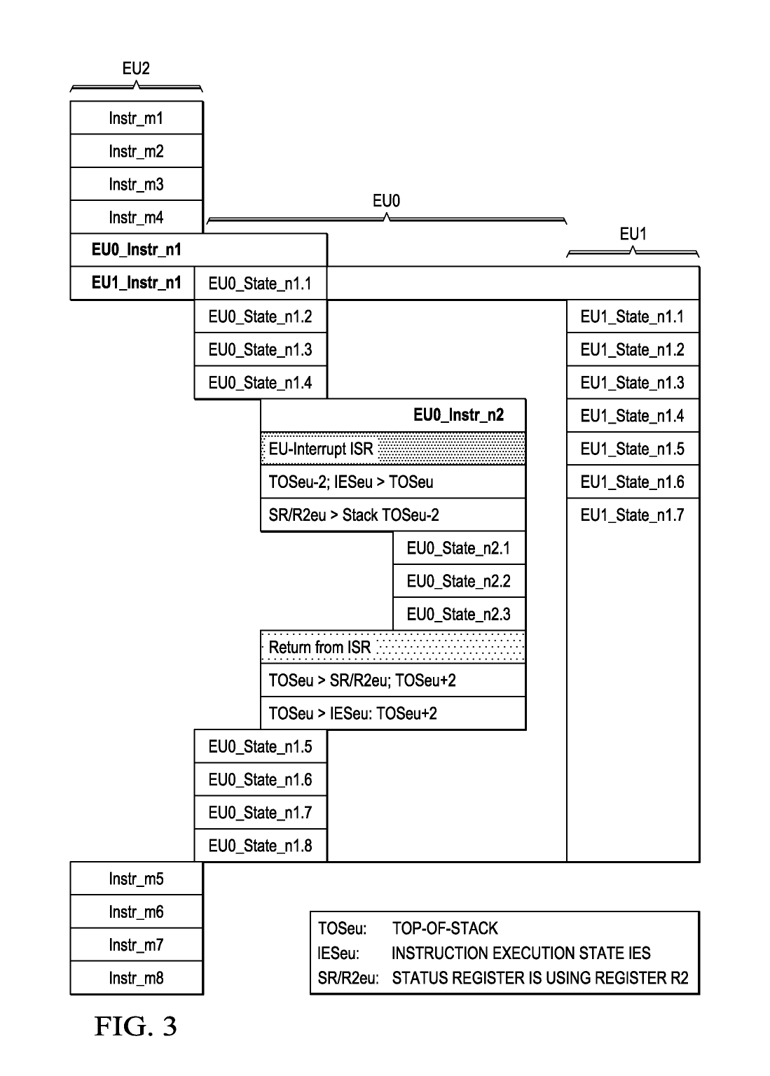

FIG. 3 shows a diagram of an exemplary instruction execution flow including interrupting of a complex instruction in accordance with various embodiments. In FIG. 3, three execution units, labeled EU0, EU1, and EU2 are executing instructions. EU0, EU1, and EU2 may each correspond to one of execution units 102-108. In FIG. 3, the instruction fetch unit 110 retrieves instructions and retrieved instructions are issued to a target execution unit. In some embodiments, fetching may be halted if an instruction to be executed has already been issued to a target execution unit and execution of the instruction is incomplete. If an execution unit that can execute the next instruction has completed execution of a last issued instruction and is ready to receive another instruction, then the next instruction is issued to the free execution unit and execution continues.

In FIG. 3, execution unit EU2 is executing the instructions Instr_m1-Instr_m4 when instruction EU0_Instr_n1 is presented for execution. EU0_Instr_n1 is a complex instruction, and is issued to execution unit EU0 for execution. Execution unit EU0 proceeds to step through the execution states of instruction EU0_Instr_n1. While execution unit EU0 is executing instruction EU0_Instr_n1, instruction EU1_Instr_n1 is presented for execution. EU1_Instr_n1 is a complex instruction and is issued to execution unit EU1 for execution.

While execution of instruction EU0_Instr_n1 is ongoing in execution unit EU0 (at state EU0_State_n1.4), instruction EU0_Instr_n2 is issued to the execution unit EU0 for execution as part of an interrupt service routine. For example, an interrupt service routine (not shown) executing on execution unit EU2 may require execution of the complex instruction EU0_Instr_n2. In response to the interrupting instruction EU0_Instr_n2, the execution unit EU0 saves status information needed to resume execution of instruction EU0_Instr_n1 at state EU0_State_n1.5 after completion of EU0_Instr_n2 execution. Thus, execution unit EU0 has full access to all information that needs to be saved prior to execution unit EU0 initiating execution of instruction EU0_Instr_n2. The execution unit EU0 sequences through the states (EU0_Instr_n2.1-EU0_Instr_n2.3) of the complex instruction EU0_Instr_n2. When execution of the instruction EU0_Instr_n2 is complete, the execution unit EU0 restores the stored instruction EU0_Instr_n1 execution status and resumes execution of the instruction EU0_Instr_n1 (e.g., states EU0_Instr_n1.5-EU0_Instr_n1.8). The execution unit EU2 may retrieve the results produced by execution of the instruction EU0_Instr_n2.

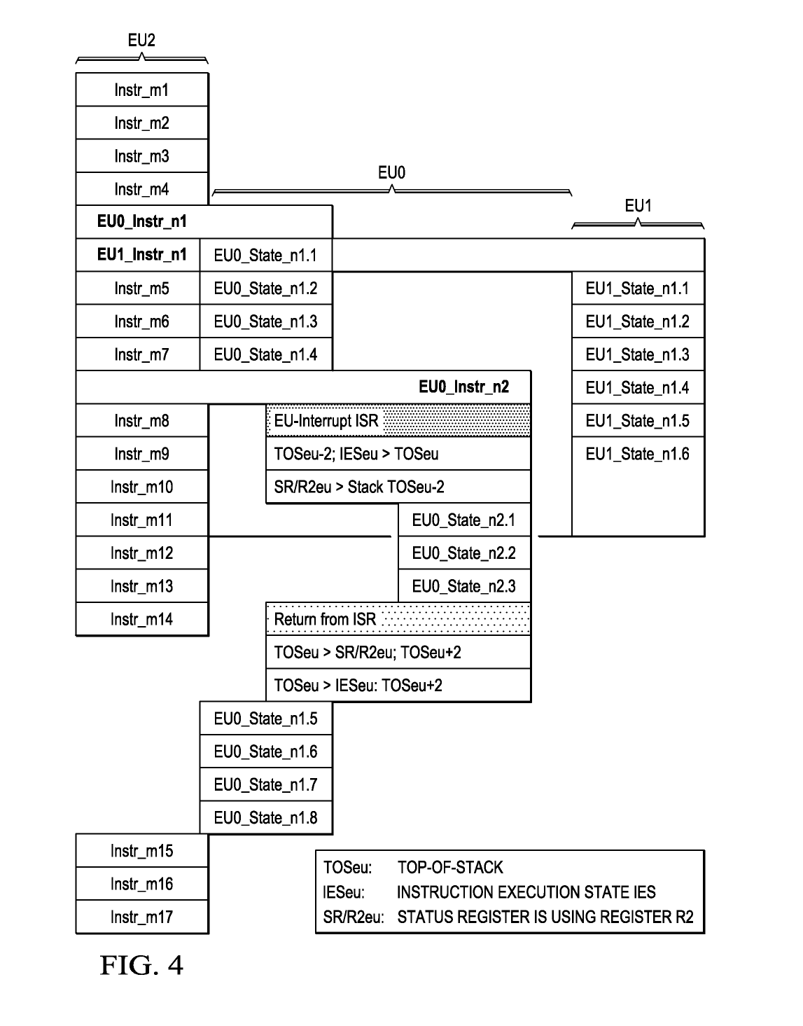

FIG. 4 shows a diagram of an exemplary instruction execution flow including interrupting of a complex instruction in accordance with various embodiments. In FIG. 4, three execution units, labeled EU0, EU1, and EU2 are executing instructions. EU0, EU1, and EU2 may each correspond to one of execution units 102-108. In FIG. 4, the instruction fetch unit 110 retrieves instructions and instructions are issued to a target execution unit.

In FIG. 4, execution unit EU2 is executing the instructions Instr_m1-Instr_m4 when instruction EU0_Instr_n1 is presented for execution. EU0_Instr_n1 is a complex instruction, and is issued to execution unit EU0 for execution. Execution unit EU0 proceeds to step through the execution states of instruction EU0_Instr_n1. While execution unit EU0 is executing instruction EU0_Instr_n1, instruction EU1_Instr_n1 is presented for execution. EU1_Instr_n1 is a complex instruction and is issued to execution unit EU1 for execution. Execution unit EU1 initiates execution of the instruction EU1_Instr_n1 while execution unit EU0 executes instruction EU0_Instr_n1 and execution unit EU2 executes instructions Instr_m5-Instr_m14.

As described above with regard to FIG. 3, execution of the instruction EU0_Instr_n1 in execution unit EU0 is interrupted and instruction EU0_Instr_n2 is executed in execution unit EU0. The execution unit EU1 completes execution of the instruction EU1_Instr_n1 with execution of state EU1_State_n1.6 and any use of a result produced by the execution of EU1_Instr_n1 is complete with the execution of instruction Instr_m11 in execution unit EU2. Execution of instructions in the execution unit EU2 is suspended after execution of instruction Instr_m14 to wait for a result produced by execution of the instruction EU0_Instr_n1 in the execution unit EU0. Results of EU0_Instr_n1 execution are available after execution of state EU0_State_n1.8. Execution unit EU2 retrieves the result and resumes execution of instructions Instr_m15-Instr_m17.

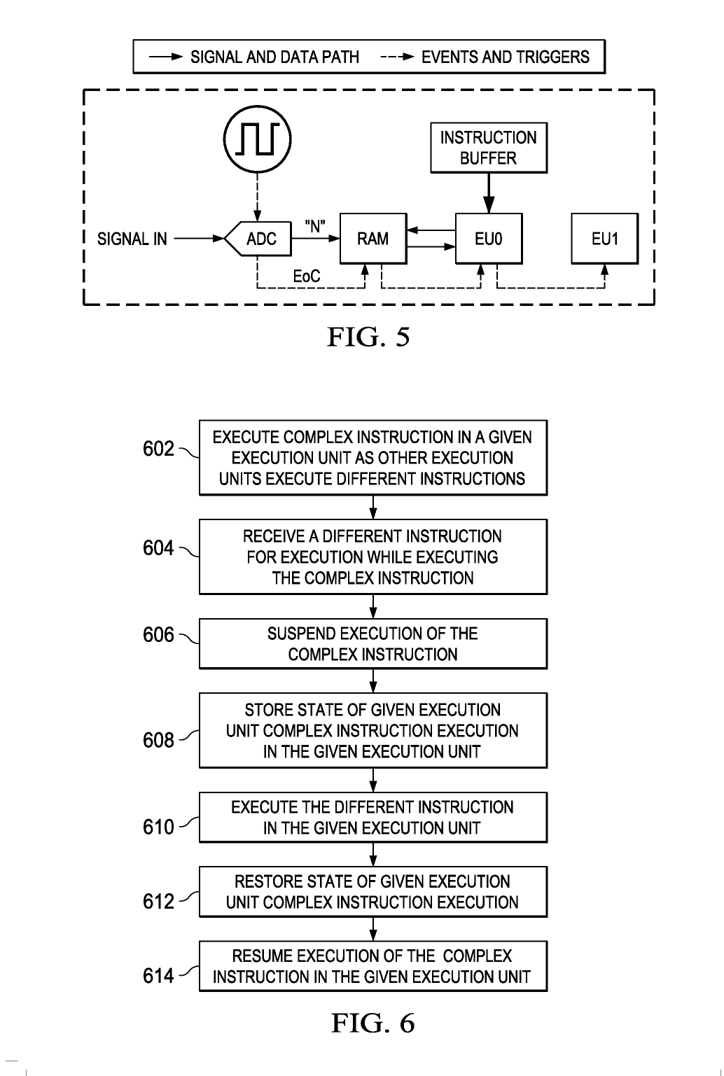

FIG. 5 shows a block diagram for an exemplary signal processing system 500 including an execution unit and instruction buffer in accordance with various embodiments. The system 500 may include or be embodied in an embodiment of the processor 100. The system 500 includes an analog-to-digital (A/D) converter 502, a memory 504, a pair of execution units 104, 102, and an instruction buffer 116. The system 500 may also include other components that have been omitted from FIG. 5 in the interest of clarity. In the system 500, the A/D converter 502 digitizes an input signal and stores the digitized signal samples in the memory 504. Embodiments of the execution units of the processor 100 are configured to initiate execution of instructions based on reception of a trigger signal. Accordingly, storing of one or more samples in the memory 504 triggers the execution unit 104 to process the sample(s). Responsive to the trigger, the execution unit 104 transitions from a low-power state to an active state and activates the instruction buffer 116. The execution unit 104 retrieves and executes instructions stored in the instruction buffer 116 to process the sample(s). For example, the execution unit 104 may be configured to execute FIR and/or FFT complex instructions, and such instructions may be provided from the instruction buffer 114 to process the sample(s). Thus, the use of the instruction buffer 116 allows the execution unit 104 to perform the required processing while the instruction fetch unit 110, other execution units and processor components, external instruction storage, etc. remain in a low-power state. When processing of the sample(s) is complete, the execution unit 104 may provide a result or notification to the execution unit 102.

FIG. 6 shows a flow diagram for a method for executing a complex instruction by a processor in accordance with various embodiments. Though depicted sequentially as a matter of convenience, at least some of the actions shown can be performed in a different order and/or performed in parallel. Additionally, some embodiments may perform only some of the actions shown.

In block 602, an execution unit (e.g., execution unit 104) of the processor 100 is executing a complex instruction. A complex instruction, such as an FFT, may require many instruction cycles to execute. As the execution unit 104 executes the complex instruction, other execution units (e.g., execution units 102, 106, 108) of the processor 100 may, in parallel, be executing different instructions.

In block 604, while executing the complex instruction, the execution unit 104 receives a different instruction to be executed. To execute the different instruction, if enabled to service interrupts, the execution unit 104, suspends (i.e., interrupts) execution of the complex instruction in block 606.

In block 608, the execution unit 104 saves the execution context of the complex instruction as of the time of suspension. For example, the execution unit 104 may store status values indicative of the state of complex instruction execution and information indicating an instruction sequence position of a next operation (e.g., a next instruction execution state, state information of an instruction sequencer state machine, etc.) to be performed when execution of the complex instruction is resumed. The information may be saved in registers or memory accessible by the execution unit 104.

In block 610, the execution unit 104 executes the different instruction. The different instruction may require one or more instruction cycles to execute. The different instruction may be followed by one or more other instructions that are executed by the execution unit 104 as part of the interrupt sequence.

In block 612, execution of the different instruction and other instructions of the interrupt sequence is complete. The execution unit 104 prepares to resume execution of the complex instruction by restoring the context of the complex instruction previously saved in block 608. For example, status and sequence information stored in block 608 are loaded into active status and execution state registers of the execution unit 104.

In block 614, the execution unit 104 resumes execution of the complex instruction at a next unexecuted state of the instruction execution. Thus, allowing for interruption of complex instructions, embodiments of the execution unit 104 provide a high level of functionality while maintaining low power consumption and real-time performance.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A processor, comprising:
a plurality of execution units, each of the execution units comprising a status register configured to store a value indicative of state of the execution unit;
at least one of the execution units is configured to:
execute a complex instruction that requires multiple instruction cycles to execute;
suspend execution of the complex instruction to execute a different instruction; and
resume, based on the value stored in the status register, execution of the complex instruction at the point interrupted after execution of the different instruction.

2. The processor of claim 1, wherein each of the execution units is configured to independently control resources of the processor external to the execution unit and needed by the execution unit to execute an instruction.

3. The processor of claim 1, wherein the execution units are configured to concurrently execute distinct instruction streams.

4. The processor of claim 1, wherein the at least one execution unit is configured to:
concatenate two instructions, wherein at least one of the two instructions is the complex instruction; and
execute the concatenated instructions as a single instruction.

5. The processor of claim 1, further comprising:
instruction fetch logic configured to fetch instructions for execution by the processor; and
an instruction buffer coupled to an output of the instruction fetch logic and coupled to an input of a given one of the at least one of the execution units;
wherein the at least one of the execution units is configured to execute instructions stored in the instruction buffer while the instruction fetch logic is in a non-operation mode.

6. The processor of claim 5, wherein the at least one of the execution units is configured to selectively execute instructions that bypass the instruction buffer.

7. The processor claim 5, wherein the execution units are configured to share the instruction buffer.

8. The processor of claim 5, wherein the given one of the at least one of the execution units is configured to:
set at least a portion of the instruction buffer to a read only mode; and
execute instructions stored in the at least a portion of the instruction buffer.

9. The processor of claim 5, further comprising an instruction decoder configured to provide decoded instructions exclusively to the at least one of the execution units.

10. The processor of claim 1, wherein the at least one of the execution units is configured to execute instructions provided by a different one of the execution units.

11. An execution unit for executing instructions in a processor, the execution unit comprising:
instruction execution logic configured to:
execute a multi-cycle instruction;
suspend execution of the multi-cycle instruction prior to completion based on reception of a different instruction by the instruction execution logic;
execute the different instruction while execution of the multi-cycle instruction is suspended; and
resume execution of the multi-cycle instruction based on completion of execution of the different instruction.

12. The execution unit of claim 11, further comprising resource control logic configured to independently control availability of resources of the processor external o the execution unit needed by the execution unit to execute an instruction.

13. The execution unit of claim 11, wherein the instruction execution logic is configured to execute instructions in parallel with execution of different instructions by different execution units.

14. The execution unit of claim 11, wherein the instruction execution logic is configured to:
concatenate a plurality of instructions, wherein at least one of the plurality of instructions is the multi-cycle instruction; and
execute the concatenated instructions as a single instruction.

15. The execution unit of claim 11, wherein the instruction execution logic is configured to:
retrieve instructions for execution from an instruction buffer of the processor; and
selectively bypass the instruction buffer to retrieve instructions for execution that are not stored in the instruction buffer.

16. The execution unit of claim 11, wherein the instruction execution logic is configured to:
set at least a portion of the instruction buffer to a read only mode; and
retrieve and execute instructions stored in the at least a portion of the instruction buffer while instruction fetching logic of the processor is in a non-operation mode.

17. The execution unit of claim 11, further comprising a status register configured to:
store information indicative of a state of execution of the multi-cycle instruction when the multi-cycle instruction is suspended; and
provide the stored information to the instruction execution logic on completion of execution of the different instruction to resume the execution of the multi-cycle instruction.

18. A method for executing instructions in an execution unit of a processor, comprising:
executing, by the execution unit, a complex instruction requiring a plurality of instruction cycles to execute;
receiving, by the execution unit, a different instruction for execution while executing the complex instruction;
suspending, by the execution unit, execution of the complex instruction responsive to the receiving;
executing, by the execution unit, the different instruction while the complex instruction is interrupted;
resuming, by the execution unit, execution of the complex instruction based on completion of execution of the different instruction.

19. The method of claim 18, wherein the interrupting comprises storing information indicative of a state of the execution unit at a time of the suspending; and the resuming comprises restoring the state of the execution unit stored based on the information stored.

20. The method of claim 18, further comprising managing, by the execution unit, at least one of power and clock resources of the processor that are external to the execution unit and needed by the execution unit to execute the complex instruction.

21. The method of claim 18, further comprising executing the complex instruction while a different execution unit executes different instructions.

22. The method of claim 18, further comprising:
concatenating, by the execution unit, a plurality of instructions, wherein one of the plurality of instructions is the complex instruction; and
executing, by the execution unit, the concatenated instructions as a single instruction.

23. The method of claim 18, further comprising:
retrieving, by the execution unit, instructions for execution from an instruction buffer of the processor while instruction fetching logic of the processor is in a non-operation mode; and
selectively bypassing, by the execution unit, the instruction buffer to retrieve instructions for execution that are not stored in the instruction buffer.

24. The method of claim 23, further comprising:
setting, by the execution unit, at least a portion of the instruction buffer to a read only mode; and
retrieving and executing, by the execution unit, instructions stored in the at least a portion of the instruction buffer.
